(19) United States
(12) Patent Application Publication
(10) Pub. No.: US 2007/0028204 A1
(43) Pub. Date: Feb. 1, 2007

(54) Method and program for high-level synthesis, and method for verifying a gate network list using the high-level synthesis method

(75) Inventor: Hideki Takeda, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/288,174

(22) Filed: Nov. 29, 2005

(30) Foreign Application Priority Data
Jul. 26, 2005 (JP) 2005-215710

(51) Int. Cl. G06F 17/50

(52) U.S. Cl. 716/18

(57) ABSTRACT

A method for high-level synthesis includes extracting difference information of a first and a second behavioral description, generating a first register transfer level description from the first behavioral description while generating mapping information of the first behavioral description and the first register transfer level description, modifying the first register transfer level description based on the difference information and the mapping information, and generating a second register transfer level description of a logic behavior equivalent to the second behavioral description.

### CROSS REFERENCE TO RELATED APPLICATIONS AND INCORPORATION BY REFERENCE

This application is based upon and claims the benefit of priority from prior Japanese Patent Application P2005-215710 filed on Jul. 26, 2005; the entire contents of which are incorporated by reference herein.

### BACKGROUND OF THE INVENTION

1. Field of the Invention

The present invention relates to an automatic high-level synthesis method, a high-level synthesis program, and an automatic method for verifying a gate network list using the high-level synthesis method.

2. Description of the Related Art

A gate netlist is modified so as to modify a logic behavior, particularly after layout data generation, in order to reduce the development period of a large scale integrated circuit (LSI). Modification of an LSI logic behavior, only by modifying a gate netlist, is referred to as an “interconnect engineering change order (ECO)”.

In the development of an LSI, an LSI gate netlist is generated from logic synthesis by using a register transfer level (RTL). Then, the results of the interconnect ECO is verified by using the RTL description. An example of verifying the interconnect ECO using the RTL description is described below.

Interconnect ECO Flow A:

(1A) Modify a section in an RTL description corresponding to a section of a logic behavior to be modified.

(2A) Modify a gate netlist corresponding to the section in the RTL description modified in the procedure 1A.

(3A) Verify the logic behavior in the RTL description modified in the procedure 1A.

(4A) Verify the logic behavior according to the gate netlist modified in the procedure 2A.

The RTL description modified in the procedure 1A may be verified as an equivalent to the gate netlist modified in the procedure 2A (formal verification), instead of using the procedure 4A. ‘Formal verification’ denotes verification of whether or not a logic behavior written in an RTL description is equivalent to a logic behavior according to a gate netlist. It is easy to correlate the RTL description to the gate netlist in the register transfer level on a one-on-one basis. Accordingly, there is rarely a problem of requiring an increased time for extracting the gate netlist in the procedure 2A.

In recent years, high-level synthesis technologies have become practicable, and accordingly, automatic high-level synthesis of an RTL description is frequently carried out, based on a behavioral description in C language or the like, so as to improve LSI development efficiency. It is also important to implement the interconnect ECO easily for LSI development by using the automatic high-level synthesis. However, there is a problem that the RTL description generated by the automatic high-level synthesis has a low level of readability, and thus processing of the procedures 1A and 2A in the interconnect ECO flow A is difficult.

To solve such a problem, a method for implementing the interconnect ECO by using a behavioral description is available. A procedure according to the method for implementing the interconnect ECO by using a behavioral description is as described below.

Interconnect ECO Flow B:

(1B) Modify a section in a behavioral description corresponding to a section of a logic behavior to be modified.

(2B) Carry out high-level synthesis of the behavioral description modified in the procedure 1B and generate an RTL description for the resulting modified logic behavior.

(3B) Modify a gate netlist corresponding to the section in the behavioral description modified in the procedure 1B.

(4B) Verify a logic behavior according to at least either the behavioral description modified in the procedure 1B or the RTL description generated in the procedure 2B.

(5B) Verify the logic behavior according to the gate netlist modified in the procedure 3B.

Verification of whether the RTL description generated in the procedure 2B is equivalent to the gate netlist modified in the procedure 3B may be carried out instead of the procedure 5B.

According to the interconnect ECO flow B, modification of the RTL description in the procedure 1A of the interconnect ECO flow A is carried out by high-level synthesis in the procedure 2B. However, even a minor change in the behavioral description may cause a significant change in the RTL description. In such case, the implementation of the procedure 3B in the interconnect ECO flow B is difficult, and the formal verification of the RTL description and the gate netlist may be inaccurate. When the formal verification is inaccurate, verification of the gate netlist cannot be omitted and takes more time than verification of the RTL description. As a result, the LSI development period due to modification of logic behavior increases.

### SUMMARY OF THE INVENTION

An aspect of the present invention inheres in a computer implemented method of high-level synthesis. The method includes extracting difference information of a first and a second behavioral description; generating a first register transfer level description from the first behavioral description while generating mapping information of the first behavioral description and the first register transfer level description; modifying the first register transfer level description, based on the difference information and the mapping information; and generating a second register transfer level description of a logic behavior equivalent to the second behavioral description.

Another aspect of the present invention inheres in a computer implemented method for verifying a gate netlist. The method includes generating a first register transfer level description from a first behavioral description of a first logic behavior while generating mapping information of the first behavioral description and the first register transfer level description, modifying the first register transfer level description, based on the mapping information and difference information of the first behavioral description and a second behavioral description of a second logic behavior in order to generate a second register transfer level description of a logic behavior equivalent to the second behavioral description; verifying the logic behavior according to the second register transfer level description; and verifying whether the second register transfer level description is equivalent to a logic behavior according to the gate netlist for the second logic behavior.

Still another aspect of the present invention inheres in a computer program product to be executed by a computer for high-level synthesis. The computer program product includes

instructions configured to extract difference information of a first and a second behavioral description; instructions configured to generate a first register transfer level description from the first behavioral description while generating mapping information of the first behavioral description and the first register transfer level description; instructions configured to modify the first register transfer level description, based on the difference information and the mapping information; and instructions configured to generate a second register transfer level description of a logic behavior equivalent to the second behavioral description.

### BRIEF DESCRIPTION OF DRAWINGS

FIG. 1 is a schematic diagram showing a structure of a high-level synthesis apparatus, according to an embodiment of the present invention;

FIG. 2 is a flowchart explaining the automatic high-level synthesis method according to the embodiment of the present invention;

FIG. 3 shows an exemplary first behavioral description according to the embodiment of the present invention;

FIG. 4 shows an exemplary second behavioral description according to the embodiment of the present invention;

FIG. 5 shows exemplary difference information according to the embodiment of the present invention;

FIG. 6 shows an exemplary first RTL description according to the embodiment of the present invention;

FIG. 7 shows exemplary mapping information according to the embodiment of the present invention;

FIG. 8 shows exemplary modification information according to the embodiment of the present invention;

FIG. 9 shows an exemplary differential RTL description according to the embodiment of the present invention;

FIG. 10 shows an exemplary second RTL description according to the embodiment of the present invention;

FIG. 11 shows an exemplary first RTL circuit according to the embodiment of the present invention;

FIG. 12 shows an exemplary second RTL circuit according to the embodiment of the present invention;

FIG. 13 is a schematic diagram showing a structure of a gate netlist verification system, according to an embodiment of the present invention;

FIG. 14 is a flowchart explaining a method for modifying a gate netlist according to the embodiment of the present invention;

FIG. 15 shows an exemplary first behavioral description according to the embodiment of the present invention;

FIG. 16 shows an exemplary first RTL description according to the embodiment of the present invention;

FIG. 17 shows an exemplary first RTL circuit according to the embodiment of the present invention;

FIG. 18 shows an exemplary second behavioral description according to the embodiment of the present invention;

FIG. 19 shows exemplary difference information according to the embodiment of the present invention;

FIG. 20 shows exemplary mapping information according to the embodiment of the present invention;

FIG. 21 shows exemplary modification information according to the embodiment of the present invention;

FIG. 22 shows an exemplary differential RTL description according to the embodiment of the present invention;

FIG. 23 shows an exemplary second RTL description according to the embodiment of the present invention;

FIG. 24 shows an exemplary second RTL circuit according to the embodiment of the present invention;

FIG. 25 shows an exemplary first behavioral description according to the embodiment of the present invention;

FIG. 26 shows an exemplary first RTL description according to the embodiment of the present invention;

FIG. 27 shows an exemplary first RTL circuit according to the embodiment of the present invention;

FIG. 28 shows an exemplary second behavioral description according to the embodiment of the present invention;

FIG. 29 shows exemplary difference information according to the embodiment of the present invention;

FIG. 30 shows exemplary mapping information according to the embodiment of the present invention;

FIG. 31 shows exemplary modification information according to the embodiment of the present invention;

FIG. 32 shows an exemplary differential RTL description according to the embodiment of the present invention;

FIG. 33 shows an exemplary second RTL description according to the embodiment of the present invention;

FIG. 34 shows an exemplary second RTL circuit according to the embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set forth such as specific signal values, etc., to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

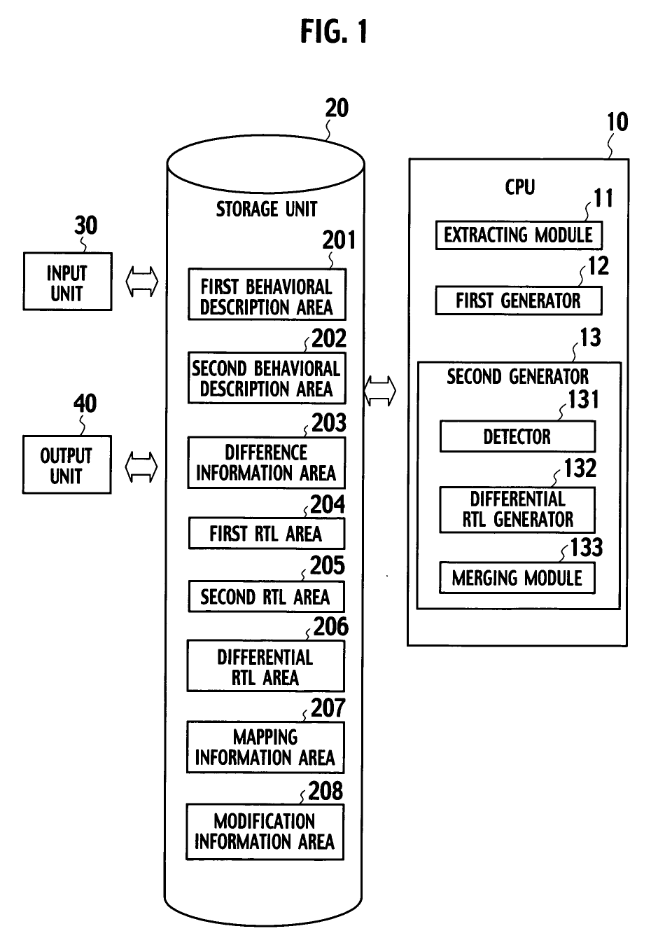

As shown in FIG. 1, a high-level synthesis apparatus according to the embodiment of the present invention comprises an extracting module 11, a first generator 12, and a second generator 13.

The extracting module 11 extracts information on the difference between a first and a second behavioral description.

‘Difference information’ includes information relating to the difference between the first and the second behavioral description. For example, difference information includes a difference in description between the first behavioral description before modification of a logic behavior and the second behavioral description after modification of the logic behavior, and a line number of the difference description or the like.

The first generator 12 generates a first RTL description from the first behavioral description while generating mapping information of the first behavioral description and the first RTL description.

‘Mapping information’ includes information of descriptions in the first RTL description corresponding to respective descriptions in the first behavioral description. For example, the mapping information includes line numbers of the description in the first behavioral description and a corresponding line number of the description in the first RTL descriptions.

The second generator 13 modifies the first RTL description, based on the difference information and the mapping information, so as to generate a second RTL description of a logic behavior equivalent to the second behavioral description.

The second generator 13 includes a detector 131, a differential RTL generator 132, and a merging module 133. The detector 131 detects a section in the first RTL description required to be modified corresponding to the difference between the first and the second behavioral description, based on the difference information and the mapping information, and generates modification information. The differential RTL generator 132 generates a differential RTL description from the difference information and the modification information. The differential RTL description includes logic behavioral description included in the difference information and the modification information. For example, when the second behavioral description is generated by modifying the first behavioral description, the differential RTL generator 132 generates a differential RTL description including a logic behavior according to the resulting modified behavioral description. The merging module 133 merges the first RTL description and the differential RTL description, into a second RTL description.

As shown in FIG. 1, a central processing unit (CPU) 10 includes the extracting module 11, the first generator 12, and the second generator 13. The high-level synthesis apparatus shown in FIG. 1 further includes a storage unit 20, an input unit 30, and an output unit 40.

The storage unit 20 includes a first behavioral description area 201, a second behavioral description area 202, a difference information area 203, a first RTL area 204, a second RTL area 205, a differential RTL area 206, a mapping information area 207, and a modification information area 208. The first behavioral description area 201 stores the first behavioral description. The second behavioral description area 202 stores the second behavioral description. The difference information area 203 stores difference information of the first and the second behavioral description. The first RTL information area 204 stores the first RTL description generated from the first behavioral description. The second RTL information area 205 stores the second RTL description generated from the second behavioral description. The differential RTL information area 206 stores a differential RTL description generated from the difference information. The mapping information area 207 stores the mapping information of the first and the second behavioral description. The modification information area 208 stores information of a section in the first RTL description to be modified.

The input unit 30 includes a keyboard, a mouse, a light pen, a flexible disk unit or the like. A high-level synthesis executer may specify and set behavioral descriptions to be input via the input unit 30. In addition, the output unit 40 includes a display and a printer, which display high-level synthesis results, or a recording unit, which stores information in a computer readable recording medium. A ‘computer readable recording medium’ refers to a medium such as an external storage unit for a computer, a semiconductor memory, a magnetic disk, or an optical disk, which may store electronic data. More specifically, a ‘computer readable recording medium’ may be a flexible disk, a compact disk read only memory (CD-ROM), or a magneto-optics (MO) disk.

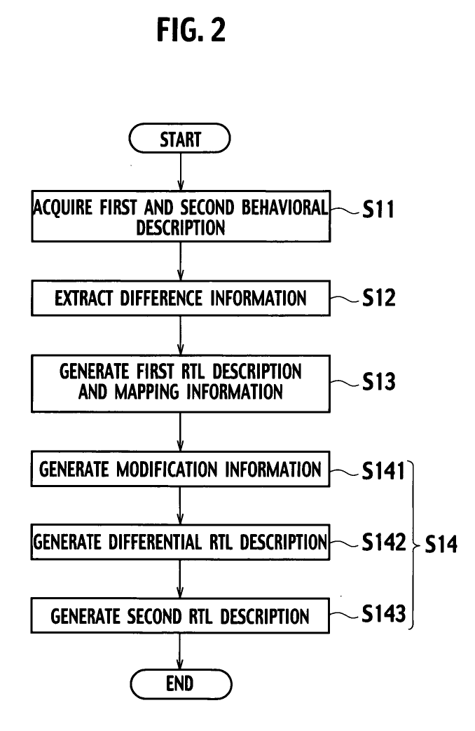

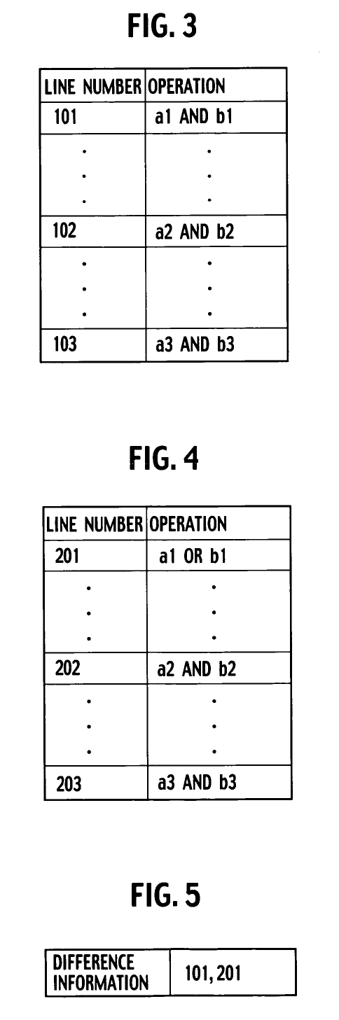

An exemplary high-level synthesis carried out by the high-level synthesis apparatus shown in FIG. 1 is described using a flowchart in FIG. 2. An example of generating an RTL description for a second logic behavior, so as to modify a first logic behavior written in a first behavioral description of FIG. 3 to a second logic behavior written in a second behavioral description in FIG. 4, is described forthwith. Note that for clarity, FIGS. 3 and 4 show only parts of a behavioral description actually available, and, as a consequence, are grammatically incomplete (as with the following description thereof).

As shown in FIG. 3, the first behavioral description includes respective AND operations for inputs ‘a1’ and ‘b1’, inputs ‘a2’ and ‘b2’, and inputs ‘a3’ and ‘b3’. On the other hand, as shown in FIG. 4, the second logic behavior includes an OR operation for the inputs ‘a1’ and ‘b1’ instead of the AND operation for the inputs ‘a1’ and ‘b1’ in the first logic behavior. In other words, in the second behavioral description, the operation using the inputs ‘a1’ and ‘b1’ in the first behavioral description is modified from the AND operation to the OR operation.

In step S11 of FIG. 2, the first behavioral description shown in FIG. 3 and the second behavioral description shown in FIG. 4 are stored in the first behavioral description area 201 and the second behavioral description area 202, respectively, via the input unit 30 shown in FIG. 1.

In step S12, the extracting module 11 reads the first and the second behavioral descriptions from the first behavioral description area 201 and the second behavioral description area 202, respectively. The extracting module 11 extracts difference information of the first and the second behavioral descriptions. FIG. 5 shows exemplary difference information. As shown in FIG. 5, line numbers 101 and 201 are extracted from the first and the second behavioral descriptions, respectively, as difference information. The extracted difference information is stored in the difference information area 203. For example, when the first and the second behavioral descriptions are written in C language, the difference information may be extracted using a ‘diff’ command.

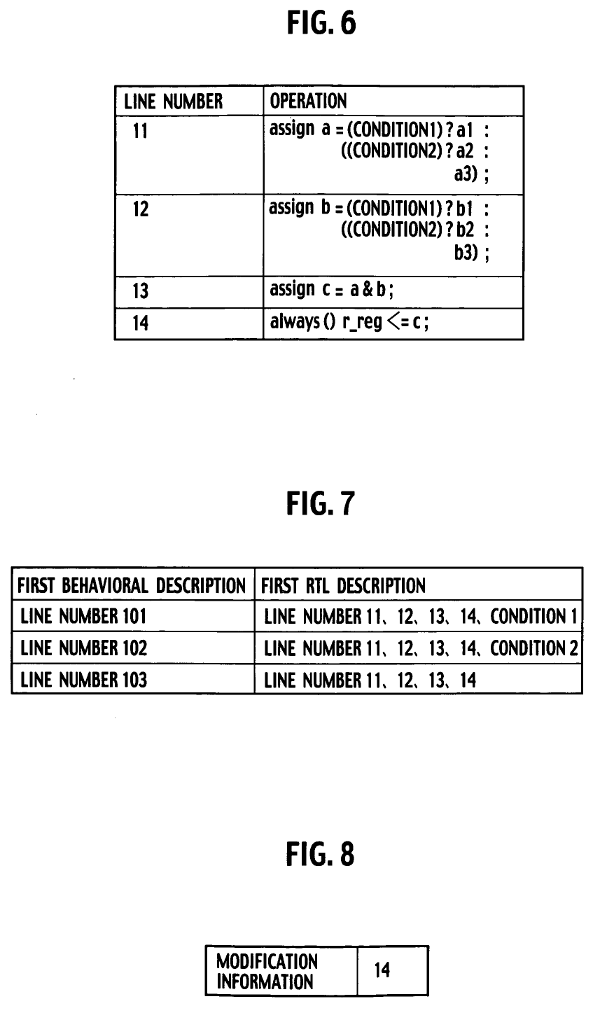

In step S13, the first generator 12 reads the first behavioral description from the first behavioral description area 201. The first generator 12 generates a first RTL description from the first behavioral description. FIG. 6 shows an exemplary first RTL description. According to the first RTL description shown in FIG. 6, an AND operation for the inputs ‘a1’ and ‘b1’ is performed when condition 1 is satisfied, while an AND operation for the inputs ‘a2’ and ‘b2’ is performed when condition 2 is satisfied. Otherwise an AND operation for the inputs ‘a3’ and ‘b3’ is performed. The AND operation results are transmitted to another arithmetic unit or are stored in a storage device such as a memory or a register. FIG. 6 shows an example of storing the AND operation results in a register. Note that for clarity, FIG. 6 shows only a part of a behavioral description actually available, and is grammatically incomplete (as with the following description). The generated first RTL description is stored in the first RTL area 204. In addition, the first generator 12 generates mapping information of the first behavioral description and the first RTL description. FIG. 7 shows exemplary mapping information. As shown in FIG. 7, the first RTL description corresponding to a line number 101 in the first behavioral description includes line numbers 11 through 14 and a condition 1. The generated mapping information is stored in the mapping information area 207.

In step S14, the second generator 13 reads difference information, mapping information, and a first RTL description from the difference information area 203, the mapping information area 207, and the first RTL area 204, respectively. The second generator 13 modifies the first RTL description based on the difference information and the mapping information, and generates a second RTL description of a logic behavior equivalent to the second behavioral description, which is described later. The generated second RTL description is stored in the second RTL area 205. The second RTL description stored in the second RTL area 205 may be transmitted externally of the high-level synthesis apparatus via the output unit 40.

An exemplary method of generating the second RTL description in step S14 is described forthwith.

In step S141, the detector 131 detects a section required to be modified in the first RTL description, due to modification of the logic behavior, based on the difference information and the mapping information, and generates modification information. Descriptions in the first RTL description corresponding to respective descriptions in the first behavioral description may be identified using the mapping information. As shown in FIG. 8, a line number 14 in the first RTL description is detected as modification information. In other words, modification of the logic behavior requires modification of the line number 14 in the first RTL description along with a description extracted as the difference information. The generated modification information is stored in the modification information area 208.

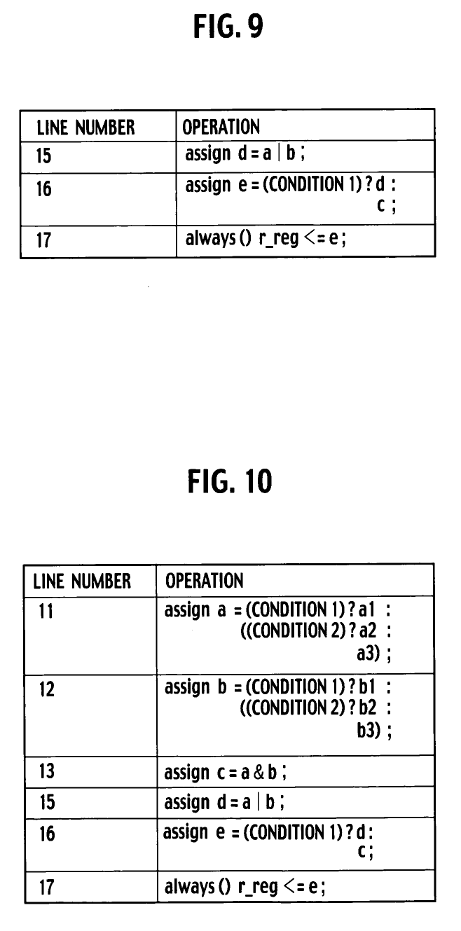

In step S142, the differential RTL generator 132 generates a differential RTL description from the difference information and the modification information. FIG. 9 shows an exemplary differential RTL description. As shown in FIG. 9, an OR operation for the inputs ‘a1’ and ‘b1’ (line number 15), selection of either the OR operation result or the AND operation result (line number 16), and storage of the selected result in a register (line number 17) are written in the differential RTL description. The generated differential RTL description is stored in the differential RTL area 206.

In step S143, the merging module 133 merges the first RTL description and the differential RTL description into the second RTL description while referencing the difference information and the modification information. More specifically, the second RTL description is generated by replacing a description in the first RTL description corresponding to the difference information and the modification information with the differential RTL description. Alternatively, the second RTL description is generated by adding the differential RTL description to the first RTL description. FIG. 10 shows the second RTL description generated by merging the first RTL description shown in FIG. 6 and the differential RTL description shown in FIG. 9.

In general, the RTL description generated from the behavioral description after modification by the automatic high-level synthesis may considerably differ from the RTL description generated from the behavioral description before modification, even if the behavioral description is barely modified. For example, the sharing of a register may occur.

According to the automatic high-level synthesis method shown in FIG. 2, only a description in the RTL description corresponding to a modified description in the behavioral description is generated as a differential RTL description. In addition, as described above, mapping information of the first behavioral description and the first RTL description is generated. Use of the mapping information facilitates identification of a section in the first RTL description required to be modified for modifying the first logic behavior to the second logic behavior. Modification of the first RTL description using the differential RTL description generates the second RTL description including fewer modifications from the first RTL description than the case of generating an additional second RTL description based on the entire modified behavioral description.

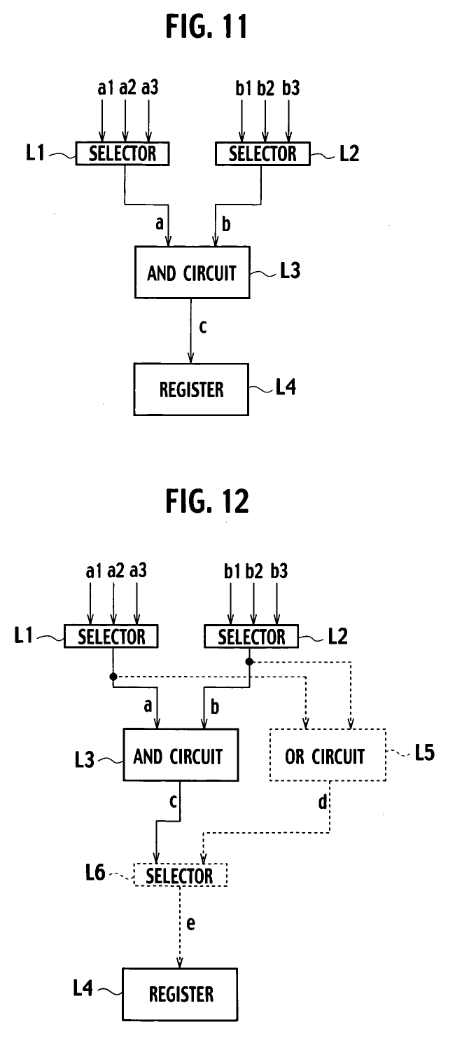

FIG. 11 shows an exemplary logic circuit (hereafter, referred to as ‘first RTL circuit’) written in the first RTL description shown in FIG. 6. As shown in FIG. 11, a selector L1 receives inputs ‘a1’ through ‘a3’. A selector L2 receives inputs ‘b1’ through ‘b3’. An AND circuit L3 receives outputs ‘a’ and ‘b’ of the respective selectors L1 and L2. The output ‘c’ of the AND circuit L3 is stored in a register L4.

FIG. 12 shows an exemplary logic circuit (hereafter, referred to as ‘second RTL circuit’) written in the second RTL description shown in FIG. 10. The second RTL circuit is different from the first RTL circuit by further including an OR circuit L5 and a selector L6. In FIG. 12, circuit blocks and interconnects indicated by dashed lines are circuit blocks and interconnects added in response to modification of a logic behavior. The OR circuit L5 receives outputs of the respective selectors L1 and L2, the selector L6 receives the outputs ‘c’ and ‘d’ of the respective AND circuit L3 and the OR circuit L5, and the output ‘e’ of the selector L6 is stored in the register L4. The selector L6 selects the output ‘d’ of the OR circuit L5 when the selectors L1 and L2 select the respective inputs ‘a1’ and ‘b1’. Alternatively, the selector L6 selects the output ‘c’ of the AND circuit L3 when the selectors L1 and L2 select the respective inputs ‘a2’ and ‘b2’ or the respective inputs ‘a3’ and ‘b3’.

As described above, the automatic high-level synthesis method shown in FIG. 2 facilitates identification of a section in the second RTL description to be modified corresponding to a description in the first RTL description. In addition, a section in a first gate netlist generated from the first RTL description, which is required to be modified, corresponding to a modified section in the second RTL description may be easily identified, based on the modified section. In other words, modification of a behavioral description in response to modification of a logic behavior implements of interconnect ECO in response to the modification of the behavioral description.

As a result, the formal verification of the second RTL description and the second gate netlist, which is generated by modifying the first gate netlist through the interconnect ECO, can be performed. Verifying the logic behavior according to the second RTL description and also verifying that the second RTL description is equivalent to the second gate netlist verifies the logic behavior according to the second gate netlist. In other words, verification of a gate netlist, which requires a longer time than verification of an RTL description, may be omitted from processing for LSI development. This procedure prevents an increase in the LSI development period due to modification of a logic behavior.

An exemplary method for verifying a logic behavior according to a gate netlist by the automatic high-level synthesis shown in FIG. 2 is described forthwith.

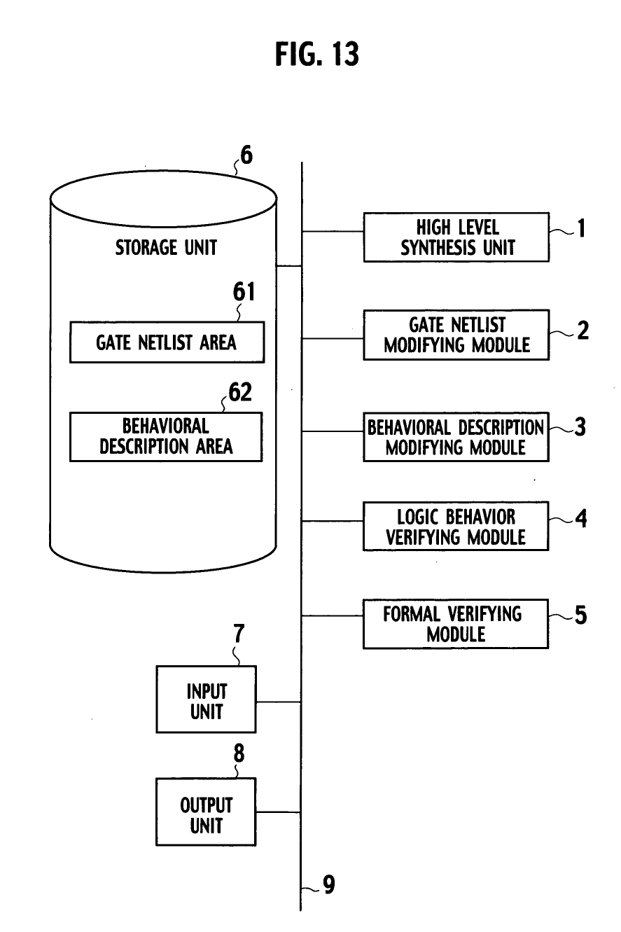

For example, a logic behavior according to the second gate netlist may be verified by a gate netlist verification system shown in FIG. 13. The gate netlist verification system shown in FIG. 13 includes a high-level synthesis unit 1, a gate netlist modifying module 2, a behavioral description modifying module 3, a logic behavior verifying module 4, a formal verifying module 5, a storage unit 6, an input unit 7, and an output unit 8. The gate netlist modifying module 2 modifies a first gate netlist for a first logic behavior, and generates a second gate netlist for a second logic behavior. The behavioral description modifying module 3 modifies a first behavioral description of the first logic behavior, and generates a second behavioral description of the second logic behavior. The high-level synthesis unit 1 generates a second RTL description in the same manner as with the method described in FIG. 2. The logic behavior verifying module 4 verifies the logic behavior according to the second RTL description. The formal verifying module 5 verifies whether or not the logic behavior according to the second RTL description is equivalent to logic behavior according to the second gate netlist.

The storage unit 6 includes a gate netlist area 61 and a behavioral description area 62. The gate netlist area 61 stores the first gate netlist and the second gate netlist. The behavioral description area 62 stores the first and the second behavioral descriptions.

A person verifying a gate netlist may specify the first gate netlist and modifying contents via the input unit 7. In addition, the person verifying the gate netlist may check the verification results via the output unit 8.

The high-level synthesis unit 1, the gate netlist modifying module 2, the behavioral description modifying module 3, the logic behavior verifying module 4, the formal verifying module 5, the storage unit 6, the input unit 7, and the output unit 8 are connected to a bus 9. Data is transferred via the bus 9.

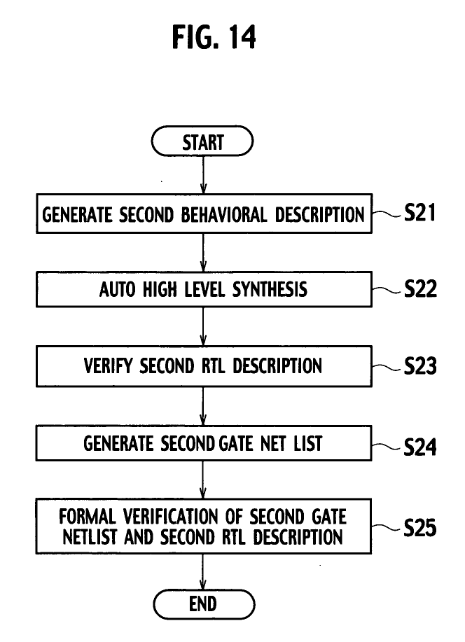

An exemplary method for modifying a gate netlist by the gate netlist verification system shown in FIG. 13 is described forthwith using a flowchart shown in FIG. 14.

In step S21, the behavioral description modifying module 3 reads a first behavioral description of the first logic behavior from the behavioral description area 62. The behavioral description modifying module 3 modifies the first behavioral description, and generates a second behavioral description of a second logic behavior. The generated second behavioral description is stored in the behavioral description area 62.

In step S22, the high-level synthesis unit 1 generates a second RTL description using the method shown in FIG. 2. In other words, the second RTL description is generated based on the first RTL description and difference information of the first and the second behavioral description while referencing mapping information of the first behavioral description and the first RTL description. The generated second RTL description is stored in the second RTL area 205 shown in FIG. 1.

In step S23, the logic behavior verifying module 4 shown in FIG. 13 reads the second RTL description from the second RTL area 205 shown in FIG. 1. The logic behavior verifying module 4 verifies the logic behavior according to the second RTL description.

In step S24, the gate netlist modifying module 2 reads the first gate netlist for the first logic behavior from the gate netlist area 61. The gate netlist modifying module 2 modifies the first gate netlist, and generates a second gate netlist for the second logic behavior. For example, the gate netlist modifying module 2 generates a second gate netlist by modifying the first gate netlist in response to the modification of the second RTL description corresponding to the first RTL description, while referencing the differential RTL description generated in step S22. The generated second gate netlist is stored in the gate netlist area 61.

In step S25, the formal verifying module 5 reads the second RTL description and the second gate netlist from the second RTL area 205 and the gate netlist area 61, respectively. The formal verifying module 5 verifies that the second RTL description is equivalent to the second gate netlist.

The logic behavior according to the second gate netlist is verified by verifying the logic behavior according to the second RTL description in step S23, and also verifying whether or not the second RTL description is equivalent to the second gate netlist in step S25.

A case of generating the second gate netlist and the second behavioral description by the gate netlist verification system of FIG. 13 has been described above. Alternatively, the second gate netlist and the second behavioral description may be generated manually. The second gate netlist and the second behavioral description generated manually are stored in the gate netlist area 61 and the behavioral description area 62, respectively, via the input unit 7.

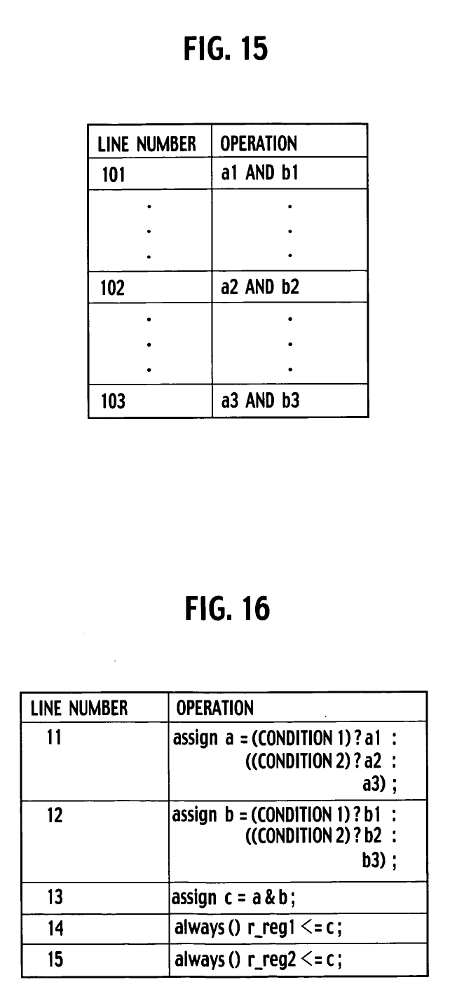

FIGS. 15 through 23 show another example of generating a second RTL description, in response to modification of types of operations, using the automatic high-level synthesis method shown in FIG. 2.

FIG. 15 shows an exemplary first behavioral description. According to the first behavioral description, the results of the AND operation are transmitted to two registers. FIG. 16 shows an exemplary first RTL description generated from the first behavioral description. The operation results for a line number 13 in FIG. 16 are stored in registers corresponding to respective line numbers 14 and 15.

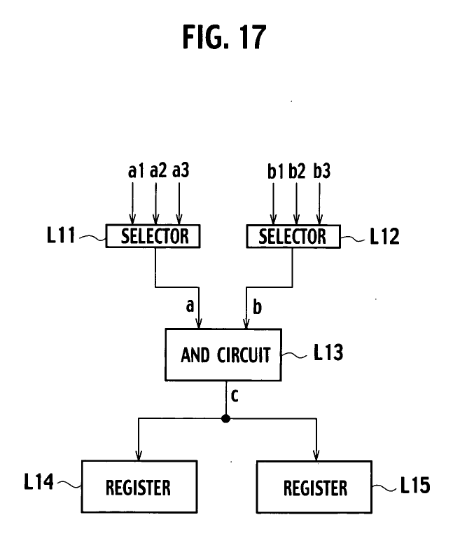

FIG. 17 shows a first RTL circuit written in the first RTL description shown in FIG. 16. Registers L14 and L15 shown in FIG. 17 correspond to arithmetic units ‘r_reg1’ and ‘r_reg2’ written to correspond to the respective line numbers 13 and 14 in FIG. 16. When selectors L11 and L12 select respective inputs ‘a3’ and ‘b3’, the output ‘c’ of an AND circuit L13 is stored in the register L14. When the selectors L11 and L12 select respective inputs ‘a2’ and ‘b2’ or respective inputs ‘a1’ and ‘b1’, the output ‘c’ of the AND circuit L13 is stored in the register L15.

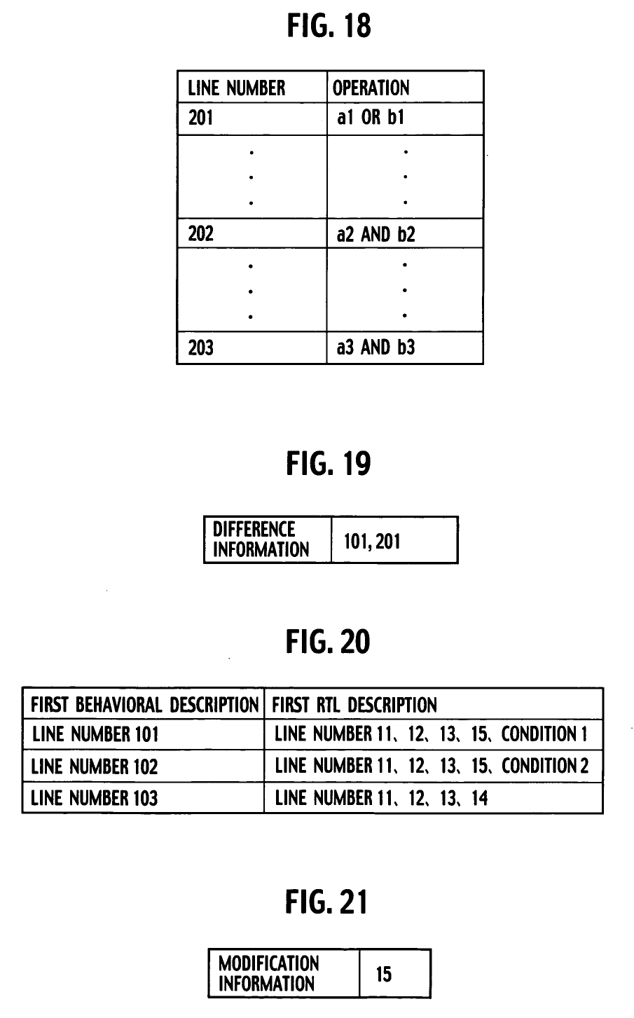

FIG. 18 shows a second behavioral description generated by modifying the first behavioral description shown in FIG. 15. According to the second behavioral description shown in FIG. 18, the operation using the inputs ‘a1’ and ‘b1’ in the first behavioral description is modified from the AND operation to an OR operation.

FIG. 19 shows difference information of the first behavioral description shown in FIG. 15 and the second behavioral description shown in FIG. 18. FIG. 20 shows mapping information of the first behavioral description shown in FIG. 15 and the first RTL description shown in FIG. 16. FIG. 21 shows modification information detected based on the difference information and the mapping information. As shown in FIG. 21, a line number 15 in the first RTL description is detected as modification information.

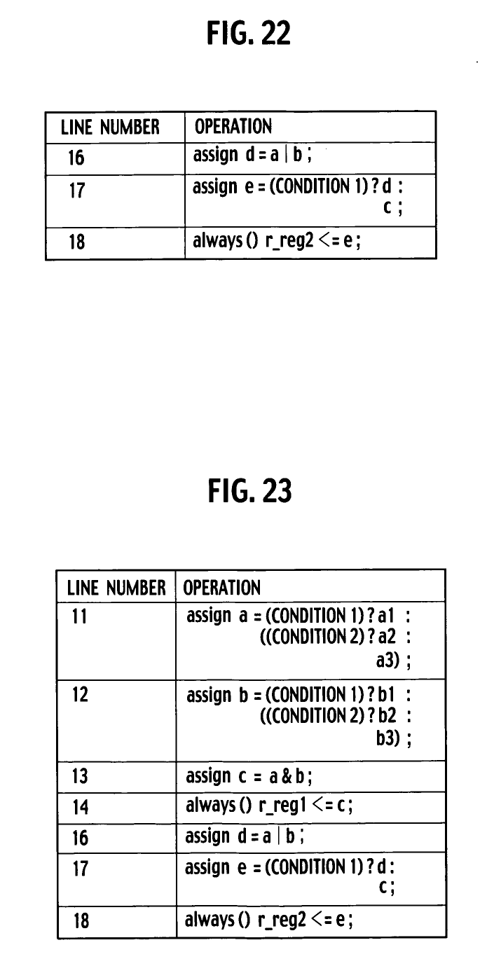

FIG. 22 shows a differential RTL description generated by the differential RTL generator 132 based on the difference information shown in FIG. 19 and the modification information shown in FIG. 21. FIG. 23 shows the second RTL description generated by the merging module 133.

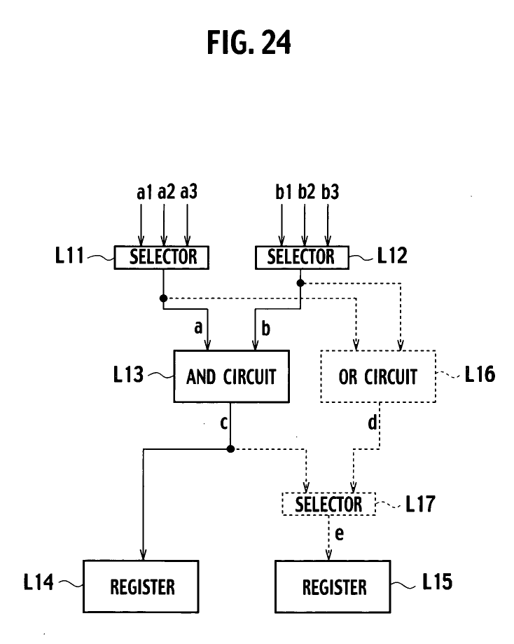

FIG. 24 shows a second RTL circuit written in the second RTL description shown in FIG. 23. In FIG. 24, circuit blocks and interconnects indicated by dashed lines are added due to modification of a logic behavior. An OR circuit L16 for operating a modified section in the behavioral description, which receives the output ‘a’ of the selector L11 and the output ‘b’ of the selector L12, is added. In addition, a selector L17, which receives the output ‘c’ of the AND circuit L13 and the output ‘d’ of the OR circuit L16, is added. The OR circuit L16 implements the OR operation for the inputs ‘a1’ and ‘b1’. A register L15 receives the output ‘e’ of the selector L17. The selector L17 selects the output ‘d’ of the OR circuit L16 when the selectors L1 and L2 select the respective inputs ‘a1’ and ‘b1’. Alternatively, the selector L17 selects the output ‘c’ of the AND circuit L13 when the selectors L1 and L2 select the respective inputs ‘a2’ and ‘b2’.

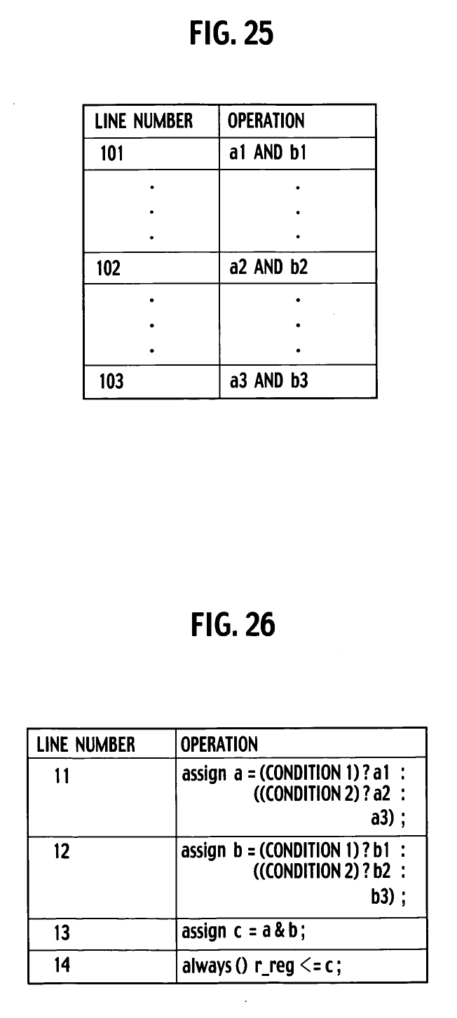

An example of generating a second RTL description corresponding to modification of the number of inputs for the operation written in a behavioral description by the automatic high-level synthesis method shown in FIG. 2 is described forthwith, using FIGS. 25 through 33.

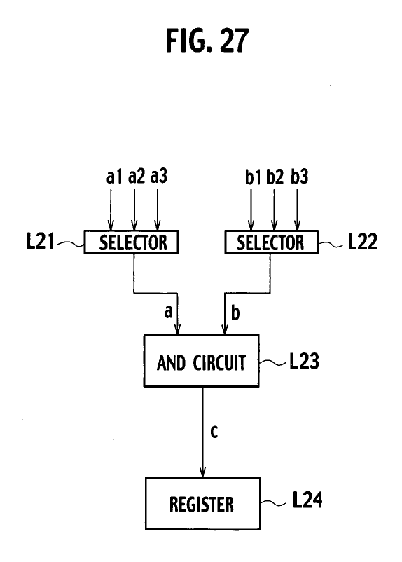

FIG. 25 shows an exemplary first behavioral description. The AND operation written in the first behavioral description shown in FIG. 25 is a two-input AND operation. FIG. 26 shows a first RTL description generated from the first behavioral description shown in FIG. 25. FIG. 27 shows a first RTL circuit written in the first RTL description shown in FIG. 26. An AND circuit L23 shown in FIG. 27 is a two-input AND circuit.

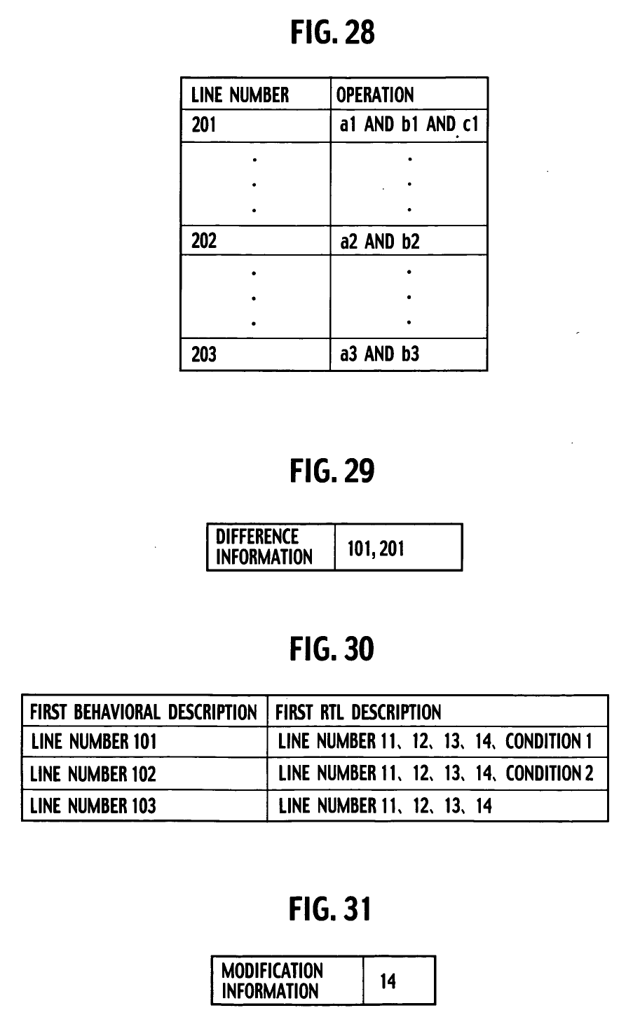

FIG. 28 shows a second behavioral description generated by modifying the first behavioral description shown in FIG. 27. In the second behavioral description shown in FIG. 28, the AND operation for the inputs ‘a1’ and ‘b1’ in the first behavioral description is modified to the AND operation for the inputs ‘a1’, ‘b1’, and ‘c1’.

FIG. 29 shows difference information of the first behavioral description shown in FIG. 25 and the second behavioral description shown in FIG. 28. FIG. 30 shows mapping information of the first behavioral description shown in FIG. 25 and the first RTL description shown in FIG. 26. FIG. 31 shows detected modification information, based on the difference information and the mapping information. As shown in FIG. 31, a line number 14 in the first RTL description is detected as modification information.

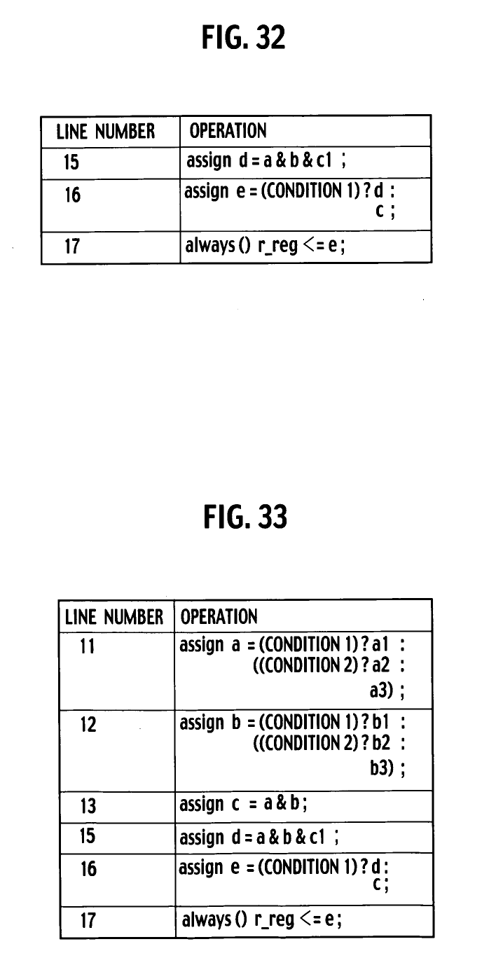

FIG. 32 shows a differential RTL description generated by the differential RTL generator 132, based on the difference information shown in FIG. 29 and the modification information shown in FIG. 31. FIG. 33 shows a second RTL description generated by the merging module 133.

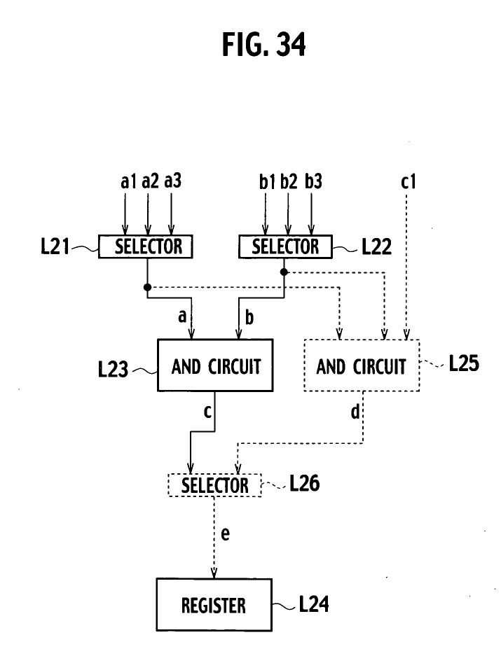

FIG. 34 shows a second RTL circuit written in the second RTL description shown in FIG. 33. In FIG. 34, circuit blocks and interconnects indicated by dashed lines are added due to modification of a logic behavior. A three-input AND circuit L25 for operating a modified section in the behavioral description is added, and an AND circuit L23 receives the outputs of the respective selectors L21 and L22. In addition, a selector L26, which receives the outputs of the respective AND circuits L23 and L25, is added. A register L24 receives the output of the selector L26. The AND circuit L25 performs an AND operation for the inputs ‘a1’, ‘b1’, and ‘c1’. The selector L26 selects the output ‘c’ of the AND circuit L23 when the selectors L21 and L22 select respective inputs ‘a2’ and ‘b2’ or respective inputs ‘a3’ and ‘b3’. Alternatively, the selector L26 selects the output ‘d’ of the AND circuit L25 when the selectors L1 and L2 select the respective inputs ‘a1’ and ‘b1’.

When an RTL description is generated by automatic high-level synthesis based on the entire modified behavioral description, an operation written in a modified section of the behavioral description and an operation written in the behavioral description before modification may share an arithmetic unit. Therefore, as described above, the RTL description generated by automatic high-level synthesis after having modified the behavioral description may considerably differ from the RTL description generated based on the behavioral description before modification. For example, if the behavioral description shown in FIG. 4 is a part of a second behavioral description, the OR logic or the modified section written in the behavioral description of FIG. 4 and other OR logics, not shown in the drawing, may share the same arithmetic unit (OR circuit). In such a case, a signal to control a selector, which selects an input for the arithmetic unit, may differ considerably before and after modification, making it difficult to modify a gate netlist through interconnect ECO. In other words, it is difficult to identify a section in a gate netlist to be modified that corresponds to the modified section in the behavioral description. As a result, the formal verification of the second RTL description and the second gate netlist is inaccurate. In such a case, since the logic behavior according to the second gate netlist needs to be verified, the LSI development period increases.

On the other hand, according to the automatic high-level synthesis method of the embodiment of the present invention, a differential RTL description is generated based on difference information of a first behavioral description before modification of a logic behavior and a second behavioral description after modification thereof. A second RTL description is then generated by merging a first RTL description that is generated based on the first behavioral description and the differential RTL description. This procedure facilitates identification of a section in the second RTL description, to be modified, which corresponds to modification of a logic behavior. As a result, the second gate netlist corresponding to the modified section in the behavioral description may be easily generated. Thus, the formal verification of the second RTL description and the second gate netlist can be performed, and an increase in the LSI development period due to modification of a logic behavior may be controlled.

A series of high-level synthesis operations shown in FIG. 2 may be carried out by controlling the high-level synthesis apparatus, shown in FIG. 1, by use of a program having an algorithm equivalent to that shown in FIG. 2. The program should be stored in the memory 20 of the high-level synthesis apparatus shown in FIG. 1. In addition, a series of high-level synthesis operations of the present invention may be carried out by storing such program in a computer-readable recording medium and instructing the memory 20, shown in FIG. 1, to read the recording medium.

Various modifications will become possible for those skilled in the art after receiving the teachings of the present disclosure without departing from the scope thereof.

What is claimed is:

1. A computer implemented method for high-level synthesis, comprising:
extracting difference information of a first and a second behavioral description;
generating a first register transfer level description from the first behavioral description while generating mapping information of the first behavioral description and the first register transfer level description;
modifying the first register transfer level description based on the difference information and the mapping information; and
generating a second register transfer level description of a logic behavior equivalent to the second behavioral description.

2. The method of claim 1, wherein generating the second register transfer level description comprises:
generating modification information by detecting a section in the first register transfer level description that is required to be modified and which corresponds to the difference between the first and the second behavioral description, based on the difference information and the mapping information;
generating a differential register transfer level description from the difference information and the modification information; and
merging the first register transfer level description and the differential register transfer level description into the second register transfer level description.

3. The method of claim 2, wherein the differential register transfer level description includes a logic behavioral description included in the difference information and the modification information.

4. The method of claim 2, wherein the second register transfer level description is generated by replacing a description in the first register transfer level description corresponding to the difference information and the modification information with the differential register transfer level description.

5. The method of claim 2, wherein the second register transfer level description is generated by adding the differential register transfer level description to the first register transfer level description.

6. The method of claim 1, wherein the difference information includes a difference in description between the first and the second behavioral description.

7. The method of claim 1, wherein the mapping information includes information of descriptions in the first register transfer level description corresponding to respective descriptions in the first behavioral description.

8. The method of claim 7, wherein the mapping information includes a line number in the first behavioral description and a corresponding line number in the first register transfer level description.

9. A computer implemented method for verifying a gate netlist, comprising:
generating a first register transfer level description from a first behavioral description of a first logic behavior while generating mapping information of the first behavioral description and the first register transfer level description, modifying the first register transfer level description based on the mapping information and difference information of the first behavioral description and a second behavioral description of a second logic behavior, in order to generate a second register transfer level description of a logic behavior equivalent to the second behavioral description;
verifying the logic behavior according to the second register transfer level description; and
verifying whether the second register transfer level description is equivalent to a logic behavior according to a gate netlist for the second logic behavior.

10. The method of claim 9, wherein generating the second register transfer level description comprises:
detecting a section in the first register transfer level description that is required to be modified and which corresponds to the difference between the first and the second behavioral description, based on the difference information and the mapping information and generating modification information;
generating a differential register transfer level description from the difference information and the modification information; and
merging the first register transfer level description and the differential register transfer level description into a second register transfer level description.

11. The method of claim 10, wherein the differential register transfer level description includes a logic behavioral description included in the difference information and the modification information.

12. The method of claim 10, wherein the second register transfer level description is generated by replacing a description in the first register transfer level description corresponding to the difference information and the modification information with the differential register transfer level description.

13. The method of claim 10, wherein the second register transfer level description is generated by adding the differential register transfer level description to the first register transfer level description.

14. The method of claim 9, wherein the difference information includes a difference in description between the first and the second behavioral description.

15. The method of claim 9, wherein the mapping information includes information of descriptions in the first register transfer level description corresponding to respective descriptions in the first behavioral description.

16. The method of claim 9, further comprising:
modifying the first behavioral description in order to generate the second behavioral description.

17. The method of claim 9, further comprising:
modifying a gate netlist for the first logic behavior in order to generate the gate netlist for the second logic behavior.

18. The method of claim 9, wherein the gate netlist for the second logic behavior is generated while referencing a differential register transfer level description generated from the difference information.

19. A computer program product to be executed by a computer for high-level synthesis, comprising:
instructions configured to extract difference information of a first and a second behavioral description;
instructions configured to generate a first register transfer level description from the first behavioral description while generating mapping information of the first behavioral description and the first register transfer level description;
instructions configured to modify the first register transfer level description, based on the difference information and the mapping information; and
instructions configured to generate a second register transfer level description of a logic behavior equivalent to the second behavioral description.

20. The computer program product of claim 19, wherein the instructions configured to generate a second register transfer level description, comprise:
instructions configured to generate modification information by detecting a section in the first register transfer level description that is required to be modified and which corresponds to the difference between the first and the second behavioral description, based on the difference information and the mapping information;
instructions configured to generate a differential register transfer level description from the difference information and the modification information; and
instructions configured to merge the first register transfer level description and the differential register transfer level description into the second register transfer level description.
